(19) United States
(12) Patent Application Publication
(10) Pub. No.: US 2020/0356485 A1
(43) Pub. Date: Nov. 12, 2020

(54) EXECUTING MULTIPLE DATA REQUESTS OF MULTIPLE-CORE PROCESSORS

(71) Applicant: INTERNATIONAL BUSINESS MACHINES CORPORATION, Armonk, NY (US)

(72) Inventors: Ralf Winkelmann, Holzgerlingen (DE); Michael Fee, Cold Spring, NY (US); Matthias Klein, Poughkeepsie, NY (US); Carsten Otte, Stuttgart (DE); Edward W. Chencinski, Poughkeepsie, NY (US); Hanno Eichelberger, Stuttgart (DE)

(21) Appl. No.: 16/407,746

(22) Filed: May 9, 2019

(51) Int. Cl. G06F 12/0855; G06F 11/30; G06F 11/32; G06F 11/34; G06F 13/16

(52) U.S. Cl. CPC G06F 12/0857; G06F 11/3027; G06F 2212/62; G06F 11/349; G06F 13/1668; G06F 11/324

(57) ABSTRACT

The present disclosure relates to a method for a computer system comprising a plurality of processor cores, wherein a cached data item is assigned to a first core of the processor cores for exclusively executing an atomic primitive by the first core. The method comprises, while the execution of the atomic primitive is not completed by the first core, receiving from a second core at a cache controller a request for accessing the data item. In response to determining that a second request of the data item is received from a third core, of the plurality of processor cores, before receiving the request of the second core, a rejection message may be returned to the second core.

### BACKGROUND

The present invention relates to the field of digital computer systems, and more specifically, to a method for a computer system comprising a plurality of processor cores.

In concurrent programming, concurrent accesses to shared resources can lead to unexpected or erroneous behavior, so parts of a program where the shared resource is accessed may be protected. This protected section may be referred to as an atomic primitive, critical section, or critical region. The atomic primitive may access a shared resource, such as a data structure that would not operate correctly in the context of multiple concurrent accesses. However, there is a need to better control the usage of an atomic primitive in a multi-core processor.

### SUMMARY

Various embodiments provide a method for a computer system comprising a plurality of processor cores, computer program product, and processor system as described by the subject matter of the independent claims. Advantageous embodiments are described in the dependent claims. Embodiments of the present invention can be freely combined with each other if they are not mutually exclusive.

In one aspect, the present disclosure relates to a method for a computer system comprising a plurality of processor cores, wherein a data item is assigned exclusively to a first core of the plurality of processor cores for executing an atomic primitive by the first core. The method comprises, while execution of the atomic primitive is not completed by the first core, receiving from a second core of the processor cores at a cache controller a request for accessing the data item; and in response to determining that another request of the data item is received from a third core, of the plurality of processor cores, before receiving the request of the second core, returning a rejection message to the second core, wherein the rejection message to the second core further indicating another request is waiting for the atomic primitive, otherwise sending an invalidation request to the first core for invalidating an exclusive access to the data item by the first core. The method further includes receiving a response from the first core indicative of a positive response to the invalidation request; and in response to the positive response to the invalidation request from the first core, the cache controller responding to the second core that the data is available for access.

In exemplary embodiments, the method further includes returning a rejection message for each received request of the data item by the cache controller, while the third core is still waiting for the data item.

In exemplary embodiments, the method further includes providing a cache protocol indicative of multiple possible states of the cache controller, wherein each state of the multiple possible states is associated with respective actions to be performed by the cache controller, the method includes receiving the request when the cache controller is in a first state of the multiple possible states, and switching by the cache controller from the first state to a second state, of the multiple possible states, such that the determining is performed in the second state of the cache controller in accordance with actions of the second state. The method further includes switching from the second state to a third state of the multiple possible states such that the returning is performed in the third state in accordance with actions associated with the third state, or switching from the second state to a fourth state of the multiple possible states such that the sending of the invalidation request, the receiving and the responding steps are performed in the fourth state in accordance with actions associated with the fourth state.

In another aspect, the present disclosure relates to a computer program product comprising one or more computer readable storage mediums collectively storing program instructions that are executable by a processor or programmable circuitry to cause the processor or the programmable circuitry to perform a method for a computer system comprising a plurality of processor cores, wherein a data item is assigned exclusively to a first core, of the plurality of processor cores, for executing an atomic primitive by the first core; the method comprising while the execution of the atomic primitive is not completed by the first core, receiving from a second core of the processor cores at a cache controller a request for accessing the data item; and in response to determining that another request of the data item is received from a third core, of the plurality of processor cores, before receiving the request of the second core, returning a rejection message to the second core, wherein the rejection message to the second core further indicating another request is waiting for the atomic primitive, otherwise sending an invalidation request to the first core for invalidating an exclusive access to the data item by the first core. The method further includes receiving a response from the first core indicative of a positive response to the invalidation request; and in response to the positive response to the invalidation request from the first core, the cache controller responding to the second core that the data is available for access.

In another aspect, the present disclosure relates to a processor system with coherency maintained by a cache controller of the processor system, the processor system comprising a plurality of processor cores, wherein a data item is assigned exclusively to a first core of the plurality of processor cores for executing an atomic primitive by the first core. The cache controller is configured, while execution of the atomic primitive is not completed by the first core, for receiving from a second core, of the plurality of processor cores, a request for accessing the data item; and in response to determining that another request of the data item is received from a third core of the plurality of processor cores before receiving the request of the second core, returning a rejection message to the second core, the rejection message to the second core further indicating another request is waiting for the atomic primitive, otherwise sending an invalidation request to the first core for invalidating an exclusive access to the data item by the first core; receiving a response from the first core indicative of a positive response to the invalidation request; and in response to the positive response to the invalidation request from the first core, the cache controller responding to the second core that the data is available for access.

In exemplary embodiments, the third core of the processor system includes a logic circuitry to execute a predefined instruction, wherein the cache controller is configured to perform the determining step in response to the execution of the predefined instruction by the logic circuitry.

### BRIEF DESCRIPTION OF THE SEVERAL VIEWS OF THE DRAWINGS

In the following embodiments the invention is explained in greater detail, by way of example only, referring to the drawings in which:

FIG. 1 depicts an example multiprocessor system, in accordance with embodiments of the present disclosure.

FIG. 2A depicts a flowchart of a method for processing data requests of multiple processor cores, in accordance with embodiments of the present disclosure.

FIG. 2B is a block diagram illustrating a method for processing data requests of multiple processor cores, in accordance with embodiments of the present disclosure.

FIG. 3 depicts a flowchart of a method to implement a lock for workload distribution in a computer system comprising a plurality of processor cores, in accordance with embodiments of the present disclosure.

### DETAILED DESCRIPTION

The descriptions of the various embodiments of the present invention will be presented for purposes of illustration, and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand.

The present disclosure may prevent that, when a given processor core enters an atomic primitive, other processor cores do not have to wait (e.g., by continuously requesting for a lock) for the given processor core until it completes the atomic primitive. The other processor cores may perform other tasks while the atomic primitive is being executed. This may enable an efficient use of the processor resources. The terms “core” and “processor core” are used interchangeably herein.

The atomic primitive may be defined by a storage location and a set of one or more instructions. The set of one or more instructions may have access to the storage location. The storage location may be associated with a lock that limits access to that location. To enter the atomic primitive the lock must be acquired. Once acquired, the atomic primitive is executed (i.e., the set of instructions are executed) exclusively by a core that acquired the lock. Once the lock is released this indicates that the core has left the atomic primitive.

According to one embodiment, the determining that the other request of the third core is received before the request of the second core comprises determining that the third core is waiting for the data item. This may, for example, be performed by using states associated with data items, wherein a state of a data item may indicate that the data item is being waited for by a given core.

According to one embodiment, the method further comprises returning a rejection message for each further received request of the data item by the cache controller, while the third core is still waiting for the data item. The further request may be received from another processor core of the processor cores. For example, the first core has a lock, and the third core is waiting for the data item. Not only does the second core get rejected by receiving a rejection message, but also, all cores after the second core would also be rejected while the third core is still waiting for the data item.

According to one embodiment, the method further comprises providing a cache protocol indicative of multiple possible states of the cache controller, wherein each state of the multiple states is associated with respective actions to be performed by the cache controller, the method comprising: receiving the request when the cache controller is in a first state of the multiple states, switching by the cache controller from the first state to a second state such that the determining is performed in the second state of the cache controller in accordance with actions of the second state, and switching from the second state to a third state of the multiple states such that the returning is performed in the third state in accordance with actions associated with the third state, or switching from the second state to a fourth state of the multiple states such that the sending of the invalidation request, the receiving and the responding steps are performed in the fourth state in accordance with actions associated with the fourth state.

According to one embodiment, the cache protocol further indicates multiple data states. The data state of a data item indicates ownership state or coherency state of the data item. The data state of the data item enables a coherent access to the data item by the multiple processor cores. The method comprises: assigning a given data state of the multiple data states to the data item for indicating that the data item belongs to the atomic primitive and that the data item is requested and being waited for by another core, wherein the determining that another request of the data item is received from the third core before receiving the request of the second core comprises determining by the cache controller that the requested data item is in the given data state. For example, cache-line metadata may be used to indicate the coherency state of the data items used in the atomic primitive.

According to one embodiment, the receiving of the request comprises monitoring a bus system connecting the cache controller and the processor cores, wherein the returning of the rejection message comprises generating a system-bus transaction indicative of the rejection message.

According to one embodiment, the method further comprises in response to determining that the atomic primitive is completed, returning the data item to the waiting third core. This may enable the third processor core to receive the requested data item without having to perform repeated requests. The second processor core, having received the reject response, may perform other tasks. This may increase the performance of the computer system by the efficient transfer of the atomic primitive to the third processor, and allowing the second core (and any subsequent core requests) to perform other work.

According to one embodiment, the method further comprises causing the second core to resubmit the request for accessing the data item after a predefined maximum execution time of the atomic primitive. For example, the causing may be performed after sending the rejection message. This may prevent that the second processor core enters a loop of repeated requests without doing any additional task.

According to one embodiment, returning the rejection message to the second core further comprises: causing the second core to execute one or more further instructions while the atomic primitive is being executed, the further instructions being different from an instruction for requesting the data item. This may enable an efficient use of the processor resources compared to the case with the second core has to wait for the first core (or first core and any waiting cores) until it finished the execution of the atomic primitive.

According to one embodiment, the execution of the atomic primitive comprises accessing data shared between the first and third cores, wherein the received request is a request for enabling access to the shared data by the second core. The data may additionally be shared with the second core.

According to one embodiment, the data item is a lock acquired by the first core to execute the atomic primitive, wherein determining that the execution of the atomic primitive is not completed comprises determining that the lock is not available. This embodiment may seamlessly be integrated in exciting systems. The lock may for example be released by a use a regular store instruction.

According to one embodiment, the cache line associated with the data item is released after the execution of the atomic primitive is completed.

According to one embodiment, the data item is cached in a cache of the first core. The cache of the first core may be a data cache or instruction cache.

According to one embodiment, the data item is cached in a cache shared between the first and second cores. The cache may additionally be shared with the third core. The cache may be a data cache or instruction cache.

According to one embodiment, the method further comprises providing a processor instruction, wherein the receiving of the request is the result of executing the processor instruction by the second core, wherein the determining and returning steps are performed in response to determining that the received request is triggered by the processor instruction. The third core may also be configured to send the request by executing the processor instruction.

The processor instruction may be named Tentative Exclusive Load&Test (TELT). The TELT instruction may be issued by the core in the same way as a Load&Test instruction. The TELT instruction can either return the cache line and do a test or can get a reject response. The reject response does not return the cache line data and therefore does not install it in the cache. Instead, the reject response is treated in the same way as if the Load&Test instruction failed. The TELT instruction may be beneficial as it may work with stiff-arming, because it is non-blocking (providing a reject response without changing a cache line state). Another advantage may be that it may provide a faster response to the requesting core such that it enables other cores to work on other tasks. Another advantage is that the TELT instruction does not steal the cache line from the lock owner (e.g., no exclusive fetch prior to unlock is needed).

The TELT instruction may have an RX or RXE format such as the LOAD Instruction. In case the data specified by the second operand of the TELT instruction is available, the data is placed at the first operand of the TELT instruction. The contents of the first operand are unspecified in case the data is not available. The resulting condition codes of the TELT instruction may be as follows: “0” indicates that the result is zero; “1” indicates that the result is less than zero; “2” indicates that the result is greater than zero and “3” indicates that the data is not available. In a typical programming sequence, depending on the condition code the result will be processed later.

The TELT instruction may be provided as part of the instruction set architecture (ISA) associated with the processor system.

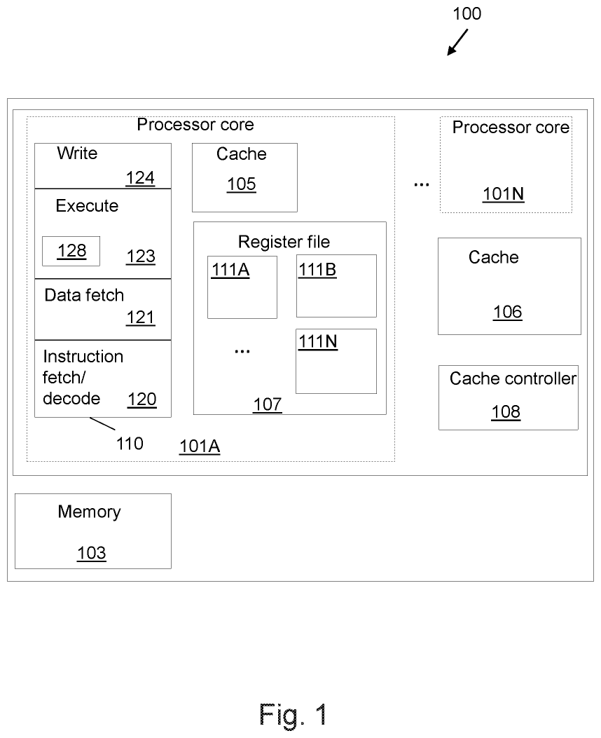

FIG. 1 depicts an example multiprocessor system 100, in accordance with embodiments of the present disclosure. The multiprocessor system 100 comprises multiple processor cores 101A-N. The multiple processor cores 101A-N may for example reside on a same processor chip such as an International Business Machines (IBM) central processor (CP) chip. The multiple processor cores 101A-N may for example share a cache 106 that resides on the same chip. The multiprocessor system 100 further comprises a main memory 103. For simplification of the description only components of the processor core 101A are described herein; the other processor cores 101B-N may have a similar structure.

The processor core 101A may comprise a cache 105 associated with the processor core 101. The cache 105 is employed to buffer memory data to improve processor performance The cache 105 is a high-speed buffer holding cache lines of memory data that are likely to be used (e.g., cache 105 is configured to cache data of the main memory 103). Typical cache lines are 64, 128 or 256 bytes of memory data. The processor core cache maintains metadata for each line it contains identifying the address and ownership state.

The processor core 101A may comprise an instruction execution pipeline 110. The execution pipeline 110 may include multiple pipeline stages, where each stage includes a logic circuitry fabricated to perform operations of a specific stage in a multi-stage process needed to fully execute an instruction. Execution pipeline 110 may include an instruction fetch and decode unit 120, a data fetch unit 121, an execution unit 123, and a write back unit 124.

The instruction fetch and decode unit 120 is configured to fetch an instruction of the pipeline 110 and to decode the fetched instruction. Data fetch unit 121 may retrieve data items to be processed from registers 111A-N. The execution unit 123 may typically receive information about a decoded instruction (e.g., from the fetch and decode unit 120) and may perform operations on operands according to the opcode of the instruction. The execution unit 123 may include a logic circuitry to execute instructions specified in the ISA of the processor core 101A. Results of the execution may be stored either in memory 103, registers 111A-N or in other machine hardware (such as control registers) by the write unit 124.

The processor core 101A may further comprise a register file 107 comprising the registers 111A-111N associated with the processor core 101. The registers 111A-N may, for example, be general-purpose registers that each may include a certain number of bits to store data items processed by instructions executed in pipeline 110.

The source code of a program may be compiled into a series of machine-executable instructions defined in an ISA associated with processor core 101A. When processor core 101A starts to execute the executable instructions, these machine-executable instructions may be placed on pipeline 110 to be executed sequentially. Instruction fetch and decode unit 120 may retrieve an instruction placed on pipeline 110 and identify an identifier associated with the instruction. The instruction identifier may associate the received instruction with a circuit implementation of the instruction specified in the ISA of processor core 101A.

The instructions of the ISA may be provided to process data items stored in memory 103 and/or in registers 111A-N. For example, an instruction may retrieve a data item from the memory 103 to a register 111A-N. Data fetch unit 121 may retrieve data items to be processed from registers 111A-N. Execution unit 123 may include logic circuitry to execute instructions specified in the ISA of processor core 101A. After execution of an instruction to process data items retrieved by data fetch unit 121, write unit 124 may output and store the results in registers 111A-N.

An atomic primitive 128 can be constructed from one or more instructions defined in the ISA of processor core 101A. The primitive 128 may for example include a read instruction executed by the processor core, and it is guaranteed that no other processor core 101B-N can access and/or modify the data item stored at the memory location read by the read instruction until the processor core 101A has completed the execution of the primitive.

The processor cores 101A-N share processor cache 106 for main memory 103. The processor cache 106 may be managed by a cache controller 108.

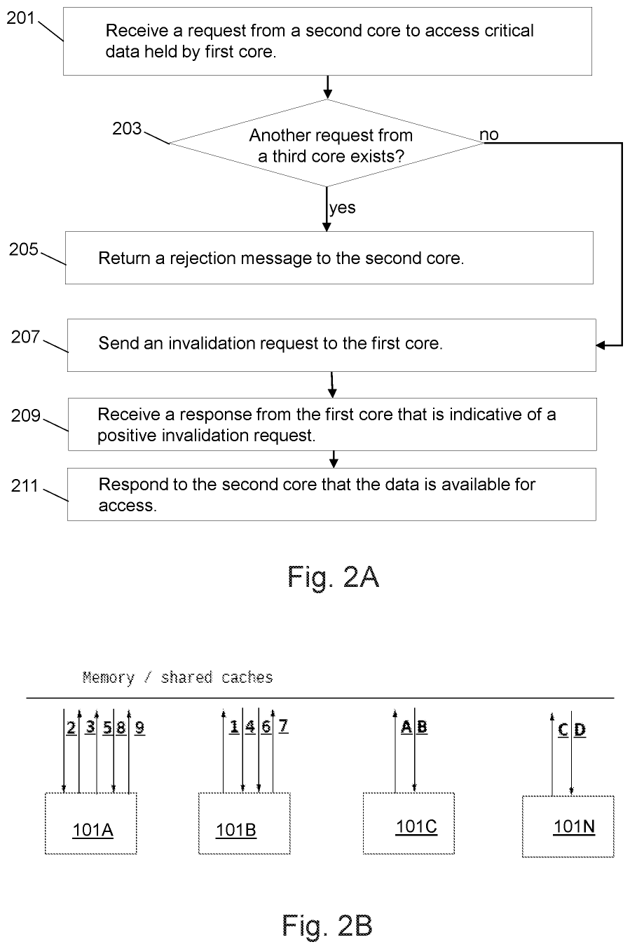

FIG. 2A depicts a flowchart of a method for processing data requests of multiple processor cores (e.g., 101A-N), in accordance with embodiments of the present disclosure. For example, one first processor core (e.g., 101A) is assigned exclusively a data item for executing an atomic primitive (e.g., 128). For example, the data item may be protected by the atomic primitive to prevent two processes from changing the content of the data item concurrently. Once entering the atomic primitive, other cores are prevented from accessing data protected by the atomic primitive and a set of one or more instructions are executed (e.g., the set of instructions have access to the protected data). Once the set of instructions are finished, the atomic primitive is left. Entering an atomic primitive may be performed by acquiring a lock and leaving the atomic primitive may be performed by releasing the lock. The releasing of the lock may, for example, be triggered by a store instruction of the set of instructions. The set of instructions may be part of the atomic primitive.

In step 201, the cache controller may receive from a second core (e.g., 101C or 101N) a request for accessing the data item. The request may for example be sent via a bus system connecting the processor cores and the cache controller. By monitoring the bus system, the cache controller may receive the request of the second processor core. The request sent by the second core may be triggered by the execution of the TELT instruction by the second core. The cache (e.g., 106) may for example comprise a cache line.

The execution of the atomic primitive by the first processor core may cause a read instruction to retrieve a data block (i.e., data item) from a memory location, and to store a copy of the data block in the cache line, thereby assigning the cache line to the first processor core. The first processor core may then execute at least one instruction while the cache line is assigned to it. While executing the at least one instruction, the request of step 201 may be received. The requested data item may, for example, be data of the cache line.

For example, a user may create a program comprising instructions that can be executed by the second processor core. The program comprises the TELT instruction. The TELT instruction enables to load a cache line in case it is available. Once the TELT instruction is executed by the second processor core the request may be issued by the second processor core. If the requested data is available, it may be returned to the second processor core. The returning of the data to the second processor core may, for example, be controlled to return only specific type of data (e.g., read-only data or other type of data).

For example, the cache controller may comprise a logic circuitry that enables the cache controller to operate in accordance with a predefined cache protocol. The cache protocol may be indicative of multiple possible states of the cache controller, wherein each state of the multiple states is associated with respective actions to be performed by the cache controller. For example, when the cache controller is in a first state of the multiple states, whenever there is any request from a processor core of the processor cores to access data, the cache controller will check whether it is a request that is triggered by the TELT instruction. The cache controller may, for example, be in the first state in step 201. The cache protocol may enable the cache controller to manage coherency. For example, the cache controller may manage the cache data and its coherency using metadata. For example, at any level of the cache hierarchy, the data backing (no cache) may be dispensed by keeping a directory of cache lines held by lower level caches.

For example, the request for accessing the data item may be a tagged request (e.g., triggered by the TELT instruction) indicating that it is a request for data being used in the atomic primitive, wherein the cache controller comprises a logic circuitry configured for recognizing the tagged request. Thus, upon receiving the request and determining that the request is triggered by the TELT instruction, the cache controller may jump to or switch to a second state of the multiple states in accordance with the cache protocol. In the second state, the cache controller may determine (inquiry step 203) if another processor core is waiting for the requested data item. For example, the cache controller maintains a state for the cache lines that it holds, and can present the state of the requested data item at the time of the request.

In response to determining (inquiry step 203) that another request of the data item is received from a third core (e.g., 101B) of the processor cores before receiving the request of the second core, the cache controller may generate a rejection message and send the rejection message in step 205 to the second core; otherwise, steps 207-211 may be performed. The determining that the other request of the third core is received before the request of the second core may be performed by determining that the requested data item is in a state indicating that that the third core is waiting for the data item. That state may further indicate that the first processor core has the target data item exclusive, but that the execution of the atomic primitive is not complete. After performing the inquiry step 203, the cache controller may switch from the second state into a third state of the multiple states in accordance with the cache protocol, wherein the rejection message is sent to the second core by execution of the actions associated with the third state.

In step 207, the cache controller may send an invalidation request (or a cross invalidation request) to the first core for invalidating the exclusive access to the data item by the first core 101A. For example, after performing the inquiry step 203, the cache controller may switch from the second state into a fourth state of the multiple states of the cache protocol. The cache controller may be configured to perform steps 207-211 when it is in the fourth state in accordance with the cache protocol.

In step 209, the cache controller may receive a response from the first core indicative of a positive response to the invalidation request. For example, the response may be sent via the bus system. By monitoring the bus system, the cache controller may receive the response.

In response to the positive response to the invalidation request from the first core, the cache controller may respond in step 211 to the second core that the data item is available for access. The response of the cache controller to the second core may for example be sent via the bus system.

Steps 201-211 may be performed while the execution of the atomic primitive is not completed by the first core 101A.

FIG. 2B is a block diagram illustrating a method for processing data requests of multiple processor cores (e.g., 101A-N), in accordance with embodiments of the present disclosure. The processor core 101A is assigned exclusively a data item for executing an atomic primitive by the processor core 101A.

A request (1) for the data item is sent by a processor core 101B to the cache controller while the processor core 101A is executing the atomic primitive. Since the request (1) received at the cache controller is the only one received, i.e., there is no other processor core waiting for the data item at the time of receiving the request (1), an invalidation request (2) is sent by the cache controller to the processor core 101A in response to receiving the request of the data item from the processor core 101B. In response to receiving the invalidation request, a positive response (3) is sent by the processor core 101A to the cache controller. In response to receiving the positive response, the cache controller may send a response (4) that indicates to the third core 101B that the requested data is available for access. FIG. 2B further depicts optional steps that may be triggered by the processor core 101A. In particular, as the processor core 101A may need to have access again to the data item, a fetch request (5) may be sent by the processor core 101A to the cache controller for gaining access to the data item. The cache controller may then send an invalidation request (6) to the processor core 101B as indicated. The processor core 101B may then send a positive response (7) to the invalidation request. Upon receiving the positive response, the cache controller may respond (8) to the processor core 101A that the data is available for access. The processor core 101A may release the lock by performing a store instruction (9), indicating that the execution of the primitive is completed. FIG. 2B further shows requests (A and C) of the data item that are received from the processor cores 101C and 101N by the cache controller while the processor core 101B is waiting for the data item. In this case, since the processor core 101B is waiting for the data item the cache controller may send a rejection message (B and D) to the processor cores 101C and 101N, respectively.

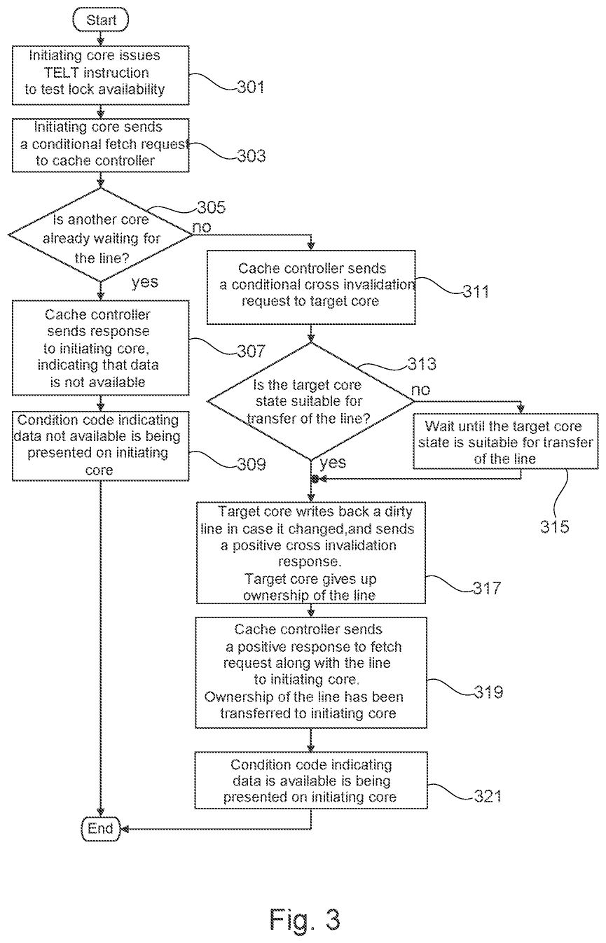

FIG. 3 depicts a flowchart of a method to implement a lock for workload distribution in a computer system comprising a plurality of processor cores, in accordance with embodiments of the present disclosure.

In step 301, an initiating processor core 101C may issue the TELT instruction to test the availability of a lock associated with an atomic primitive being executed by target processor core 101A. This may cause the initiating processor core 101C to send in step 303 a conditional fetch request for the cache line to the cache controller 108. In response to receiving the conditional fetch request, the cache controller 108 may determine (inquiry step 305) if another core is already waiting for the cache line.

If it is determined that another core (e.g., 101B) is waiting for the cache line, the cache controller may send in step 307 a response (rejection message) to the initiating processor core 101C indicating that data is not available. In step 309, a condition code indicating that the data is not available may be presented on the initiating processor core 101C.

If it is determined that no other core is waiting for the cache line, the cache controller 108 may send in step 311, a conditional cross invalidation request to the target core 101A. In inquiry step 313, it may be determined if the target core state is suitable for cache line transfer. If so, steps 317-321 may be performed, otherwise steps 315-321 may be performed.

In step 315, the cache controller may wait for the target core to complete updating the data (cache line).

In step 317, the target core 101A writes back a dirty line and sends a positive cross invalidation response, thereby the target processor core 101A gives up ownership of the requested cache line. In step 319, the cache controller 108 sends a positive response to a conditional fetch request to respective initiating processor core along with the cache line. The ownership of the cache line is transferred to respective initiating processor core. In step 321, a condition code indicating that the data is available may be presented on respective initiating processor core.

In another example, a method is provided to implement a lock for workload distribution in a computer system comprising a plurality of processor cores, the processor cores sharing a processor cache for a main memory, and the processor cache being managed by a cache controller. The method comprises: in response to a tentative exclusive load and test instruction for a main memory address, a processor core sending a conditional cross invalidation request for the main memory address to the cache controller; in response to a conditional cross invalidation request from an initiating processor core, the cache controller determining if the processor cache is available for access by the initiating processor core, and if the processor cache is not available, the cache controller responding to the initiating processor core that the data on the main memory address is not available for access, otherwise the cache controller sending a cross invalidation request to the target processor core currently owning the cache line for the main memory address; in response to the cross invalidation request from the cache controller, the target processor core writing back the dirty cache line in case it changed it, releasing ownership for the cache line, and responding to the cache controller with a positive cross invalidation request; in response to a positive cross invalidation request from the target processor core, the cache controller responding to the initiating processor core that the targeted data is available for access.

Various embodiments are specified in the following numbered clauses.

1. A method for a computer system comprising a plurality of processor cores, wherein a data item is assigned exclusively to a first core of the processor cores for executing an atomic primitive by the first core; the method comprising, while the execution of the atomic primitive is not completed by the first core, receiving from a second core of the processor cores at a cache controller a request for accessing the data item; and in response to determining that another request of the data item is received from a third core of the processor cores before receiving the request of the second core, returning a rejection message to the second core; the reject message to the second core further indicating another request is waiting for the atomic primitive, otherwise sending an invalidation request to the first core for invalidating an exclusive access to the data item by the first core; receiving a response from the first core indicative of a positive response to the invalidation request; and in response to the positive response to the invalidation request from the first core, the cache controller responding to the second core that the data is available for access.

2. The method of clause 1, wherein determining that the other request of the third core is received before the request of the second core comprises determining that the third core is waiting for the data item.

3. The method of clause 1 or 2, further comprising returning a rejection message for each further received request of the data item by the cache controller, while the third core is still waiting for the data item.

4. The method of any of the preceding clauses, further comprising providing a cache protocol indicative of multiple possible states of the cache controller, wherein each state of the multiple states is associated with respective actions to be performed by the cache controller, the method comprising: receiving the request when the cache controller is in a first state of the multiple states, switching by the cache controller from the first state to a second state such that the determining is performed in the second state of the cache controller in accordance with actions of the second state, and switching from the second state to a third state of the multiple states such that the returning is performed in the third state in accordance with actions associated with the third state, or switching from the second state to a fourth state of the multiple states such that the sending of the invalidation request, the receiving and the responding steps are performed in the fourth state in accordance with actions associated with the fourth state.

5. The method of clause 4, the cache protocol further indicating multiple data states, the method comprising: assigning a given data state of the multiple data states to the data item for indicating that the data item belongs to the atomic primitive and that the data item is requested and being waited for by another core, wherein the determining that another request of the data item is received from the third core before receiving the request of the second core comprises determining by the cache controller that the requested data item is in the given data state.

6. The method of any of the preceding clauses, the receiving of the request comprises monitoring a bus system connecting the cache controller and the processor cores, wherein the returning of the rejection message comprises generating a system-bus transaction indicative of the rejection message.

7. The method of any of the preceding clauses, further comprising in response to determining that the atomic primitive is completed, returning the data item to the third core.

8. The method of any of the preceding clauses, wherein returning the rejection message to the second core further comprises: causing the second core to execute one or more further instructions while the atomic primitive is being executed, the further instructions being different from an instruction for requesting the data item.

9. The method of any of the preceding clauses, wherein the execution of the atomic primitive comprises accessing data shared between the first and second cores, wherein the received request is a request for enabling access to the shared data by the second core.

10. The method of any of the preceding clauses, wherein the data item is a lock acquired by the first core to execute the atomic primitive, wherein determining that the execution of the atomic primitive is not completed comprises determining that the lock is not available.

11. The method of any of the preceding clauses, wherein the cache line is released after the execution of the atomic primitive is completed.

12. The method of any of the preceding clauses, wherein the data item is cached in a cache of the first core.

13. The method of any of the preceding clauses 1-11, wherein the data item is cached in a cache shared between the first and third cores.

14. The method of any of the preceding clauses, further comprising providing a processor instruction, wherein the receiving of the request is the result of executing the processor instruction by the second core, wherein the determining and returning steps are performed in response to determining that the received request is triggered by the processor instruction.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for a computer system comprising a plurality of processor cores, wherein a data item is assigned exclusively to a first core of the plurality of processor cores for executing an atomic primitive by the first core, the method comprising, while the execution of the atomic primitive is not completed by the first core:
introducing a tentative exclusive load and test (TELT) processor instruction without changing a cache line state, wherein the TELT instruction can test the availability of a lock associated with the atomic primitive being executed;
receiving from a second core of the plurality of processor cores at a cache controller a request for accessing the data item;
upon determining that the received request from the second core is triggered by the TELT instruction, presenting the cache line state of the requested data item at the time of the request; and
in response to determining that the request for the data item is received from a third core of the plurality of processor cores before receiving the request from the second core, returning a rejection message to the second core indicating that another request is waiting to use the atomic primitive, otherwise:
sending an invalidation request to the first core for invalidating an exclusive access to the data item by the first core;
receiving a response from the first core indicative of a positive response to the invalidation request; and
in response to the positive response to the invalidation request from the first core, the cache controller responding to the second core that the data item is available for access.

2. The method of claim 1, wherein determining that the request from the third core is received before the request from the second core comprises determining that the third core is waiting for the data item.

3. The method of claim 1, further comprising returning a rejection message for each further received request for the data item by the cache controller, while the third core is still waiting for the data item.

4. The method of claim 1, further comprising providing a cache protocol indicative of multiple possible states of the cache controller, wherein each state of the multiple possible states is associated with a respective action to be performed by the cache controller, the method comprising:
receiving the request when the cache controller is in a first state of the multiple possible states;
switching by the cache controller from the first state to a second state of the multiple possible states such that the determining is performed in the second state of the cache controller in accordance with actions of the second state; and
switching from the second state to a third state of the multiple possible states such that the returning is performed in the third state in accordance with actions associated with the third state, or switching from the second state to a fourth state of the multiple possible states such that the sending of the invalidation request, the receiving and the responding steps are performed in the fourth state in accordance with actions associated with the fourth state.

5. The method of claim 4, the cache protocol further indicating multiple data states, the method comprising:
assigning a given data state of the multiple data states to the data item for indicating that the data item belongs to the atomic primitive and that the data item is requested and being waited for by another core, wherein the determining that the request for the data item is received from the third core before receiving the request from the second core comprises determining by the cache controller that the requested data item is in the given data state.

6. The method of claim 1, wherein the receiving of the request comprises:
monitoring a bus system connecting the cache controller and the plurality of processor cores, wherein the returning of the rejection message comprises generating a system-bus transaction indicative of the rejection message.

7. The method of claim 1, further comprising:
in response to determining that the atomic primitive is completed, giving the data item to the third core.

8. The method of claim 1, wherein returning the rejection message to the second core further comprises:
causing the second core to execute one or more further instructions while the atomic primitive is being executed, the further instructions being different from an instruction for requesting the data item.

9. The method of claim 1, wherein the execution of the atomic primitive comprises:
accessing data shared between the first core and the second core, wherein the received request is a request for enabling access to the shared data by the second core.

10. The method of claim 1, wherein the data item comprises data that a lock is being requested for and acquired by the first core to execute the atomic primitive, and wherein determining that the execution of the atomic primitive is not completed comprises determining that the lock is not available.

11. The method of claim 1, wherein a cache line is released after the execution of the atomic primitive is completed.

12. The method of claim 1, wherein the data item is cached in a cache of the first core.

13. The method of claim 1, wherein the data item is cached in a cache shared between the first core and the third core.

14. The method of claim 1, further comprising:
providing a processor instruction, wherein the receiving of the request is the result of executing the processor instruction by the second core, and wherein the determining and returning steps are performed in response to determining that the received request is triggered by the processor instruction.

15. A processor system comprising a cache controller and a plurality of processor cores, wherein a data item is assigned exclusively to a first core of the plurality of processor cores for executing an atomic primitive by the first core, the cache controller being configured, while the execution of the atomic primitive is not completed by the first core, for:
introducing a tentative exclusive load and test (TELT) processor instruction without changing a cache line state, wherein the TELT instruction can test the availability of a lock associated with the atomic primitive being executed;
receiving from a second core of the plurality of processor cores at a cache controller a request for accessing the data item;
upon determining that the request is triggered by the TELT instruction, presenting the cache line state of the requested data item at the time of the request; and
in response to determining that the request for the data item is received from a third core of the plurality of processor cores before receiving the request from the second core, returning a rejection message to the second core indicating that another request is waiting to use the atomic primitive, otherwise:
sending an invalidation request to the first core for invalidating an exclusive access to the data item by the first core;
receiving a response from the first core indicative of a positive response to the invalidation request; and
in response to the positive response to the invalidation request from the first core, the cache controller responding to the second core that the data item is available for access.

16. The processor system of claim 15, wherein the third core includes a logic circuitry to execute a predefined instruction, wherein the cache controller is configured to perform the determining step in response to the execution of the predefined instruction by the logic circuity.

17. The processor system of claim 15, wherein determining that the request from the third core is received before the request from the second core comprises determining that the third core is waiting for the data item.

18. The processor system of claim 15, further comprising returning a rejection message for each further received request for the data item by the cache controller, while the third core is still waiting for the data item.

19. The processor system of claim 15, further comprising providing a cache protocol indicative of multiple possible states of the cache controller, wherein each state of the multiple possible states is associated with a respective action to be performed by the cache controller, the method comprising:
receiving the request when the cache controller is in a first state of the multiple possible states;
switching by the cache controller from the first state to a second state of the multiple possible states such that the determining is performed in the second state of the cache controller in accordance with actions of the second state; and
switching from the second state to a third state of the multiple possible states such that the returning is performed in the third state in accordance with actions associated with the third state, or switching from the second state to a fourth state of the multiple possible states such that the sending of the invalidation request, the receiving and the responding steps are performed in the fourth state in accordance with actions associated with the fourth state.

20. The processor system of claim 19, the cache protocol further indicating multiple data states, the method comprising:
assigning a given data state of the multiple data states to the data item for indicating that the data item belongs to the atomic primitive and that the data item is requested and being waited for by another core, wherein the determining that the request the data item is received from the third core before receiving the request from the second core comprises determining by the cache controller that the requested data item is in the given data state.

21. A computer program product comprising one or more computer readable storage mediums collectively storing program instructions that are executable by a processor or programmable circuitry to cause the processor or the programmable circuitry to perform a method for a computer system comprising a plurality of processor cores, wherein a data item is assigned exclusively to a first core, of the plurality of processor cores, for executing an atomic primitive by the first core; the method comprising while the execution of the atomic primitive is not completed by the first core:
introducing a tentative exclusive load and test (TELT) processor instruction without changing a cache line state, wherein the TELT instruction can test the availability of a lock associated with the atomic primitive being executed;
receiving from a second core of the plurality of processor cores at a cache controller a request for accessing the data item;
upon determining that the request is triggered by the TELT instruction, presenting the cache line state of the requested data item at the time of the request; and
in response to determining that the request for the data item is received from a third core of the plurality of processor cores before receiving the request from the second core, returning a rejection message to the second core indicating that another request is waiting to use the atomic primitive, otherwise:
sending an invalidation request to the first core for invalidating an exclusive access to the data item by the first core;
receiving a response from the first core indicative of a positive response to the invalidation request; and
in response to the positive response to the invalidation request from the first core, the cache controller responding to the second core that the data item is available for access.

22. The computer program product of claim 21, wherein determining that the request from the third core is received before the request from the second core comprises determining that the third core is waiting for the data item.

23. The computer program product of claim 21, further comprising returning a rejection message for each further received request for the data item by the cache controller, while the third core is still waiting for the data item.

24. The computer program product of claim 21, further comprising providing a cache protocol indicative of multiple possible states of the cache controller, wherein each state of the multiple possible states is associated with a respective action to be performed by the cache controller, the method comprising:
receiving the request when the cache controller is in a first state of the multiple possible states;
switching by the cache controller from the first state to a second state, of the multiple possible states, such that the determining is performed in the second state of the cache controller in accordance with actions of the second state; and
switching from the second state to a third state of the multiple possible states such that the returning is performed in the third state in accordance with actions associated with the third state, or switching from the second state to a fourth state of the multiple possible states such that the sending of the invalidation request, the receiving and the responding steps are performed in the fourth state in accordance with actions associated with the fourth state.

25. The computer program product of claim 24, the cache protocol further indicating multiple data states, the method comprising:
assigning a given data state of the multiple data states to the data item for indicating that the data item belongs to the atomic primitive and that the data item is requested and being waited for by another core, wherein the determining that the request for the data item is received from the third core before receiving the request from the second core comprises determining by the cache controller that the requested data item is in the given data state.
